(19) United States
(12) Patent Application Publication
(10) Pub. No.: US 2004/0150659 A1
(43) Pub. Date: Aug. 5, 2004

(54) Image processing apparatus and method

(75) Inventors: Masaki Nakano, Kanagawa (JP); Takashi Tsunoda, Kanagawa (JP); Kenichiro Ono, Kanagawa (JP); Hideaki Yui, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/626,723

(22) Filed: Jul. 25, 2003

Related U.S. Application Data
(63) Continuation of application No. PCT/JP02/13380, filed on Dec. 20, 2002.

(30) Foreign Application Priority Data
Dec. 28, 2001 (JP) 2001-398875

(51) Int. Cl. G09G 5/00

(52) U.S. Cl. 345/629

(57) ABSTRACT

An image processing apparatus of the present invention is constituted by input means for inputting first image data and second image data, determining means for determining a display position of the second image, and display control means for superimposing one of the first image and the second image on the other and displaying the first and second images on a monitor such that the second image is positioned in the display position determined by the determining means, in which the determining means determines a display position of the second image such that the display position is changed within a range that is apart from the display position determined last time by a predetermined number of pixels.

This application is a continuation of International Application No. PCT/JP02/13380, filed Dec. 20, 2002, which claims the benefit of Japanese Patent Application No. 2001-398875, filed Dec. 28, 2001.

### BACKGROUND OF THE INVENTION

1. Field of the Invention

The present invention relates to an image processing apparatus and an image processing method for compositing to display a plurality of images.

2. Description of Related Art

In general, in a self-luminescent type image display apparatus such as a CRT or a PDP, “persistence” tends to occur. “Persistence” is a phenomenon that causes reduction of an amount of emitted light only in a part of a screen where an identical image continues to be displayed. In a monitor of a computer that continues to display an identical image, if no instruction for operation is given to the computer for a predetermined time, a “persistence” prevention program called a screen saver starts up and displays an image that changes as time elapses on the screen.

As an example of the screen saver, Japanese Patent Application Laid-open No. 7-199889 discloses a system for displaying an image in a reduced size on a window smaller than an area where an image display apparatus can be displayed and, at the same time, moving this window as time elapses, thereby preventing a specific image from continuing to be displayed in a specific position of the image display apparatus.

Japanese Patent Application Laid-open No. 2000-227775 discloses a system for moving an entire displayed image continually by a degree of several pixels that is not offending visually, thereby preventing a specific image from continuing to be displayed in a specific position of an image display apparatus.

In addition, a screen saver function as disclosed in Japanese Patent Application Laid-open No. 7-199889 is devised on the premise that it is used with a computer. It functions when an operator is not operating the computer, in general, when the operator is not watching a screen of the computer.

In recent years, digitalization of televisions such as BS digital broadcasting and terrestrial digital broadcasting has advanced. A television receiver (system) corresponding to the digitization displays a plurality of images simultaneously or displays a symbol image including various kinds of icons according to an OSD system as indications for various operations. A boundary part of windows in the case of multi-window display for displaying a plurality of images simultaneously and a symbol image including icons always displayed in an identical part can be causes of persistence.

In the case of a television, it is necessary to continue to display images whether or not the television receives an operational instruction. Thus, it is impossible to cause the screen saver function as disclosed in Japanese Patent Application Laid-open No. 7-199889 to work.

The system disclosed in Japanese Patent Application Laid-open No. 2000-227775 is also effective in the case in which a fixed image is continuously displayed. However, a drawing area that is larger than an area of all pixels of a displayed image and an area for displaying no image around the drawing area have to be prepared, or an area around a displayed image has to be trimmed and displayed. Moreover, an entire screen always moves. Thus, there is an inconvenience in that the system gives a sense of discomfort to viewers.

### SUMMARY OF THE INVENTION

Under such a background, the present invention has been devised in order to solve problems such as those described above. It is an object of the present invention to appropriately shift a display position of a symbol image or a multi-window by several pixels and cause it to change, and prevent the symbol image or the multi-window from being always displayed in an identical position, thereby preventing or reducing persistence of a fixed pattern.

In addition, it is another object of the present invention to blur a display boundary part of a symbol image or a multi-window or cause the display boundary part to change in position subtly every time the symbol image or multi-window is displayed, thereby preventing persistence of a fixed pattern and making it less conspicuous.

Under such objects, according to the present invention, as an embodiment mode thereof, there is provided an image processing apparatus, including:

input means for inputting first image data and second image data;

determining means for determining a display position of the second image; and

display control means for superimposing one of the first image and the second image on the other and displaying the first and second images on a monitor such that the second image is positioned in the display position determined by the determining means;

in which the determining means determines a display position of the second image such that the display position is changed within a range that is apart from the display position determined last time by a predetermined number of pixels.

Objects of the present invention other than the above and characteristics of the objects will be apparent from the following detailed description of an embodiment mode of the present invention with reference to drawings.

### BRIEF DESCRIPTION OF THE DRAWINGS

FIG. 1 is a block diagram showing a structure of a multi-window composition unit in first and third embodiments;

FIGS. 2A, 2B, 2C, 2D and 2E are diagrams showing an example of a displayed image and timing for switching image data;

FIG. 3 shows an example of a circuit of synchronizing signal converters 20, 22 and 24;

FIGS. 4A, 4B, 4C, 4D, 4E, 4F, 4G, 4H and 4I show examples of a wave form of each part of the circuit shown in FIG. 3;

FIG. 5 is a flow chart for determination of a display position;

FIGS. 6A, 6B and 6C show first to third examples of display position history data;

FIG. 7 is a block diagram showing a structure of a multi-window composition unit in a second embodiment;

FIGS. 8A, 8B and 8C are examples of display of a composited image;

FIG. 9 shows an example of image display in the third embodiment;

FIG. 10 is a block diagram showing a structure of a multi-window composition unit in a fourth embodiment;

FIG. 11 shows an example of a screen structure in the fourth embodiment;

FIGS. 12A, 12B and 12C show examples of a waveform of image data in the fourth embodiment;

FIG. 13 is a block diagram of a schematic structure of a multi-window composition unit in a fifth embodiment;

FIG. 14 shows an example of a screen structure in the fifth embodiment;

FIGS. 15A, 15B and 15C are examples of a waveform of image data in the fifth embodiment;

FIG. 16 is a block diagram showing a structure of a multi-window composition unit in a sixth embodiment;

FIG. 17 shows an example of a screen structure in the sixth embodiment;

FIGS. 18A, 18B and 18C show examples of a waveform in the sixth embodiment;

FIG. 19 is a block diagram showing a structure of a multi-window composition unit in a seventh embodiment;

FIG. 20 shows an example of a screen structure in the seventh embodiment;

FIG. 21 shows an example of a screen structure in an eighth embodiment;

FIGS. 22A, 22B and 22C show examples of a waveform in the eighth embodiment; and

FIG. 23 shows an example of display for expanding and reducing an image size.

### DESCRIPTION OF THE PREFERRED EMBODIMENTS

An embodiment mode of the present invention will be hereinafter described in detail based on the accompanying drawings.

Embodiments of the present invention will be hereinafter described in detail with reference to the accompanying drawings.

### First Embodiment

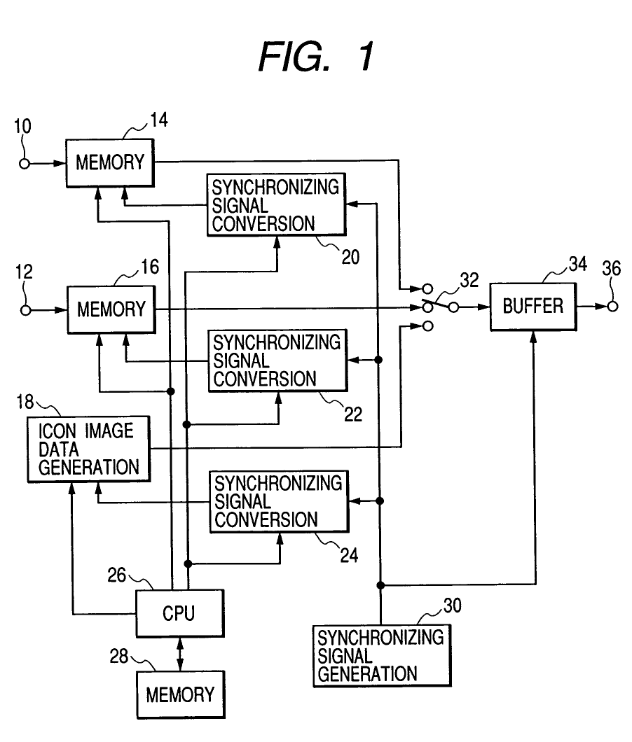

FIG. 1 shows a block diagram of a schematic structure of a multi-window composition unit for a television receiver that is a first embodiment of the present invention.

In the figure, reference numeral 10 denotes a first digital image signal input terminal and 12 denotes a second digital image signal input terminal. Reference numerals 14 and 16 denote first and second image memories for storing image data for one frame inputted from the first and second digital image signal input terminals 10 and 12. Reference numeral 18 denotes an icon image data generator for generating image data of an icon image to be displayed as a symbol.

Reference numerals 20, 22 and 24 denote first, second and third synchronizing signal converters for staggering timing of an inputted synchronizing signal to output the synchronizing signal; 26, a CPU for controlling the multi-window composition unit; 28, a nonvolatile memory such as an EEPROM for storing a history of each image display position and a program to be executed in the CPU 26; and 30, a synchronizing signal generator.

Reference numeral 32 denotes an image data selector for switching image data from the first and second image memories 14 and 16 and the icon image data generator 18 one by one; 34, an image data output buffer; and 36, an image data output terminal.

A not-shown image source, for example, a digital broadcast receiving tuner, an image data recording medium such as an HDD, an A/D converter for quantizing an analog image signal, or the like are connected to the first and second image signal input terminals 10 and 12. Image data inputted from the image source is written in the first and second image memories 14 and 16 once. Then, the image data is expanded or reduced to an image size corresponding to an instruction from the CPU 26, and priority information of each image is added to the image data. The image data is read out to the image data selector 32 in synchronism with a synchronizing signal from the first and second synchronizing signal converters 20 and 22. The priority information added to the image data is data of 2 bits added to each pixel. The data consists of “00” in an invalid image period and consists of “01” or “10” in a valid image period. The priority information is set by the CPU 26.

The icon image data generator 18 generates image data for icons in accordance with an instruction from the CPU 26 and outputs the image data together with its priority information to the image data selector 32 in synchronism with a synchronizing signal from the third synchronizing signal converter 24. The priority information of the image data for icons is “11” for a pixel in which an icon exists and “00” for a pixel in which no icon exists.

The image data selector 32 selects each image data from the first and second image memories 14 and 16 and the icon image data generator 18 one by one and outputs the image data in synchronism with a synchronizing signal. The image data selector 32 selects each image data based on the priority information added to each image data. That is, the image data selector 32 selects, for each pixel, image data having priority information with a largest value. If the priority data of any image data is “00”, the image data selector 32 selects no image data and replaces all bits with “0”. In this way, the image data selector 32 composites each image data. An image composited in this way is outputted from the image data output terminal 36 via the image data output buffer 34. A not-shown image display device displays image data outputted from the image data output terminal 36 as an image.

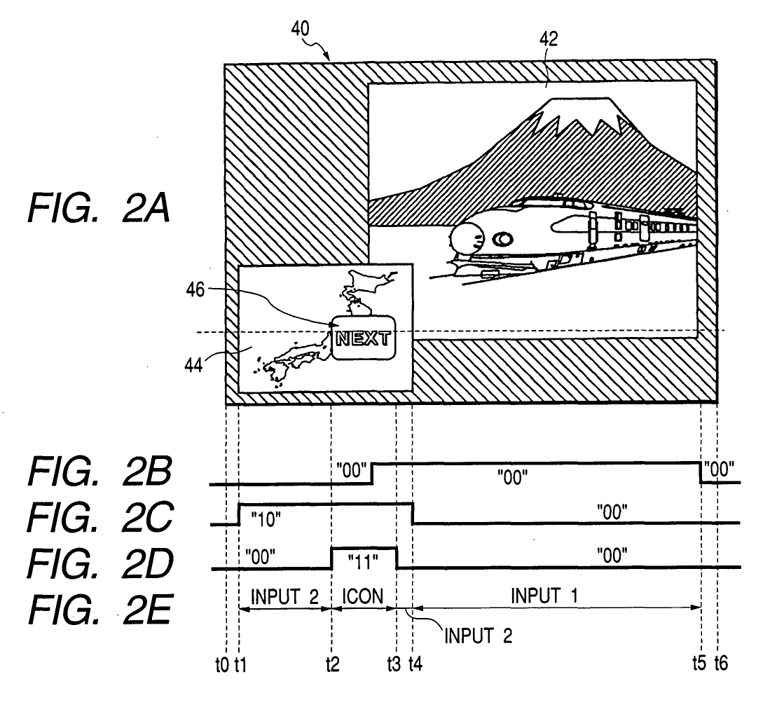

FIGS. 2A to 2E show an example of an image composited by the multi-window composition unit and timing for switching image data. FIGS. 2A to 2E are explanatory views of a screen drawn on the image display device. FIG. 2A shows an example of a displayed image. FIGS. 2B to 2E show timing on one line corresponding to a part indicated by a broken line in FIG. 2A.

In FIG. 2A, reference numeral 40 denotes a background where no image is drawn. Here, it is assumed that the background 40 is colored only in black. Reference numeral 42 denotes an image consisting of a pattern of the Shinkannsen of image data to be inputted in the image signal input terminal 10. Reference numeral 44 denotes an image consisting of a pattern of the map of Japan of image data to be inputted in the image signal input terminal 12. Reference numeral 46 denotes an icon image from the icon image data generator 18.

FIGS. 2B, 2C, 2D and 2E show priority information of image data from the image signal input terminal 10, priority information of image data from the image signal input terminal 12, priority information of icon image data from the icon image data generator 23, and a result of selection by the image data selector 32, respectively.

In the figures, t0 indicates drawing start timing of one line, and t6 indicates drawing finish timing of one line. Each image is switched at each timing of t1, t2, t3, t4 and t5. In the periods of t0 to t1 and t5 to t6, since priority information of all sources is “00”, the selector 32 does not select any image data. In the period of t4 to t5, since priority information “01” of the image data (pattern of the Shinkansen) from the image signal input terminal 10 is a maximum value, the selector 32 selects image data from the first image memory 14. In the periods of t1 to t2 and t3 to t4, since priority information “10” of the image data (pattern of the map of Japan) from the image signal input terminal 12 is a maximum value, the selector 32 selects image data from the second image memory 16. In the period of t3 to t4, since priority information “11” of the icon data from the icon image data generator 18 is a maximum value, the selector 32 selects icon image data from the icon image data generator 18.

In this way, when selection by the image data selector 32 is switched for each pixel according to priority information, an image is composited as shown in FIG. 2A.

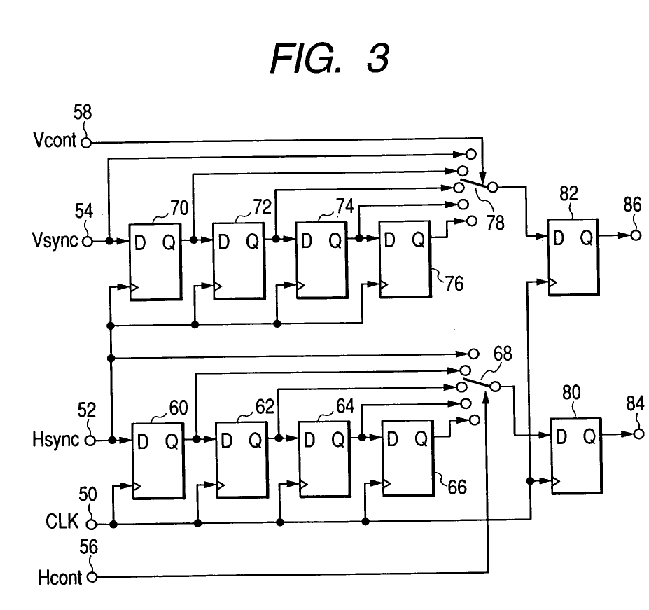

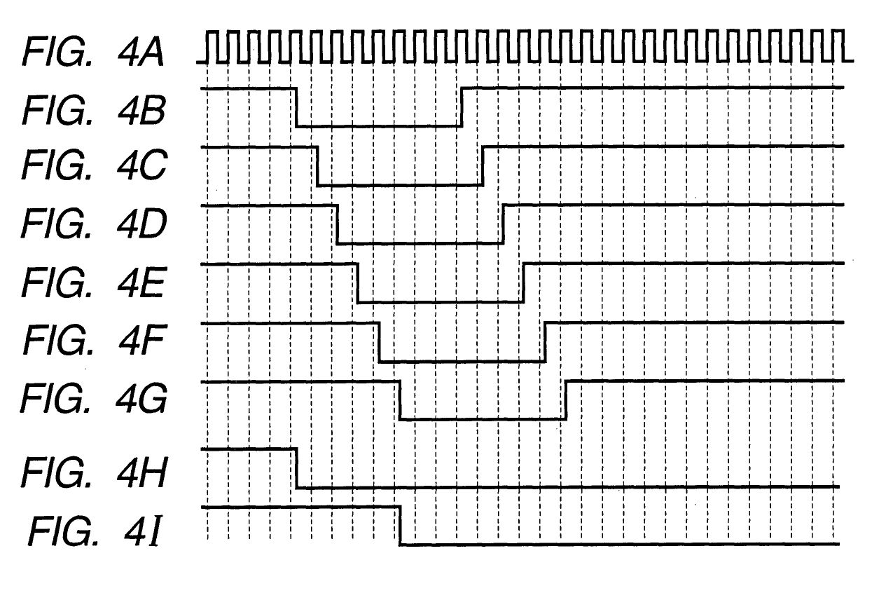

A function characteristic of this embodiment resides in the synchronizing signal converters 20, 22 and 24. FIG. 3 shows an example of a detailed circuit structure of the synchronizing signal converters 20, 22 and 24. FIGS. 4A to 4I show waveforms (timing) of each part of the synchronizing signal converters shown in FIG. 3.

Reference numeral 50 denotes an input terminal of a pixel clock CLK; 52, an input terminal of a horizontal synchronizing signal Hsync; 54, an input terminal of a vertical synchronizing signal Vsync; 56, an input terminal of a horizontal timing control signal Hcont; and 58, an input terminal of a vertical timing control signal Vcont.

Reference numerals 60, 62, 64 and 66 denote D flip flops serially connected to each other, and 68 denotes a multiplexer for selecting an input signal of the input terminal 52 and outputs of the D flip flops 60, 62, 64 and 66 in accordance with the horizontal timing control signal Hcont from the input terminal 56.

Reference numerals 70, 72, 74 and 76 denote D flip flops serially connected to each other, and 78 denotes a multiplexer for selecting an input signal of the input terminal 54 and outputs of the D flip flops 70, 72, 74 and 76 in accordance with the vertical timing control signal Vcont from the input terminal 58.

Reference numeral 80 denotes a D flip flop for latching an output of the multiplexer 68 in accordance with a clock from the input terminal 50; 82, a D flip flop for latching an output of the multiplexer 78 in accordance with a clock from the input terminal 50; 84, an output terminal for outputting a horizontal synchronizing signal from the D flip flop 80; and 86, an output terminal for outputting a vertical synchronizing signal from the D flip flop 82 FIG. 4A shows a pixel clock CLK inputted in the input terminal 50. FIG. 4B shows a horizontal synchronizing signal Hsync inputted in the input terminal 52. FIGS. 4C to 4F show outputs of the D flip flops 60, 62, 64 and 66, respectively. FIG. 4G shows a horizontal synchronizing signal Hsync outputted from the output terminal 84. FIG. 4H shows a vertical synchronizing signal inputted in the input terminal 54. FIG. 4I shows a signal waveform of a vertical synchronizing signal Vsync outputted from the output terminal 84.

As shown in FIGS. 4C, 4D, 4E and 4F, the D flip flops 60, 62, 64 and 66 delay the horizontal synchronizing signal Hsync by one pixel for each stage. The multiplexer 68 selects any one of these horizontal synchronizing signals delayed by one to four pixels and the horizontal synchronizing signal Hsync that is not delayed.

Similarly, as to vertical synchronizing signals, the multiplexer 78 selects any one of vertical synchronizing signals delayed by one to four horizontal scanning periods by the D flip flops 70, 72, 74 and 76 and a vertical synchronizing signal that is not delayed.

The horizontal synchronizing signal and the vertical synchronizing signal selected by the multiplexers 68 and 78 are timed by the D flip flops 80 and 82 and outputted from the output terminals 84 and 86, respectively.

The selections by the multiplexers 68 and 78 are controlled by the horizontal timing control signal Hcont and the vertical timing control signal Vcont from the CPU 26, respectively. A horizontal synchronizing signal output and a vertical synchronizing signal output that are staggered in timing in the range of one to five pixels both horizontally and vertically are obtained according to a combination of the horizontal timing control signal Hcont and the vertical timing control signal Vcont.

For example, FIGS. 4A to 4I show cases in which the multiplexer 68 selects an output of the D flip-flop 66 and the multiplexer 78 selects a vertical synchronizing signal input. In this case, as shown in FIG. 4F, a horizontal synchronizing signal delayed by four clocks with respect to an input and a vertical synchronizing signal without delay with respect to an input are inputted in the D flip flops 80 and 82, respectively. The D flip flops 80 and 82 time changing points of both the inputs, and as shown in FIGS. 4G and 4I, output the horizontal synchronizing signal Hsync and the vertical synchronizing signal Vsync that are delayed by five pixels in the horizontal direction and by zero pixel in the vertical direction with respect to the input.

In this way, the horizontal synchronizing signal and the vertical synchronizing signal that are staggered in timing in the range of one to five pixels are used, respectively, and image data and priority information accompanying the image data are read out from the first and second image memories 14 and 16 and the icon image data generator 18, whereby the switching timing in the image data selector 32 is also staggered in the range of one to five pixels in the horizontal and vertical directions.

A method with which the CPU 26 determines delayed time in the horizontal and vertical directions of the synchronizing signal converters 20, 22 and 24 will be described. In this embodiment, a variable range of a display position is five pixels for both horizontally and vertically. Therefore, there are shift patterns of display position for five pixels horizontally and vertically, respectively, that is, there are shift patterns of display position of twenty-five types in total. Any one of these twenty-five shift patterns of display position will be selected. A shift pattern of display position with a shortest accumulated time among display accumulated times of the twenty-five shift patterns of display position is selected and set, whereby a display accumulated time in each display position can be uniformalized as much as possible.

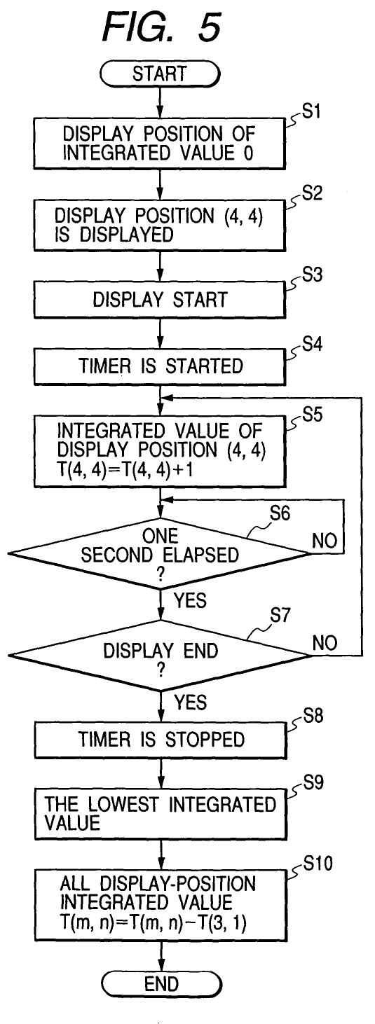

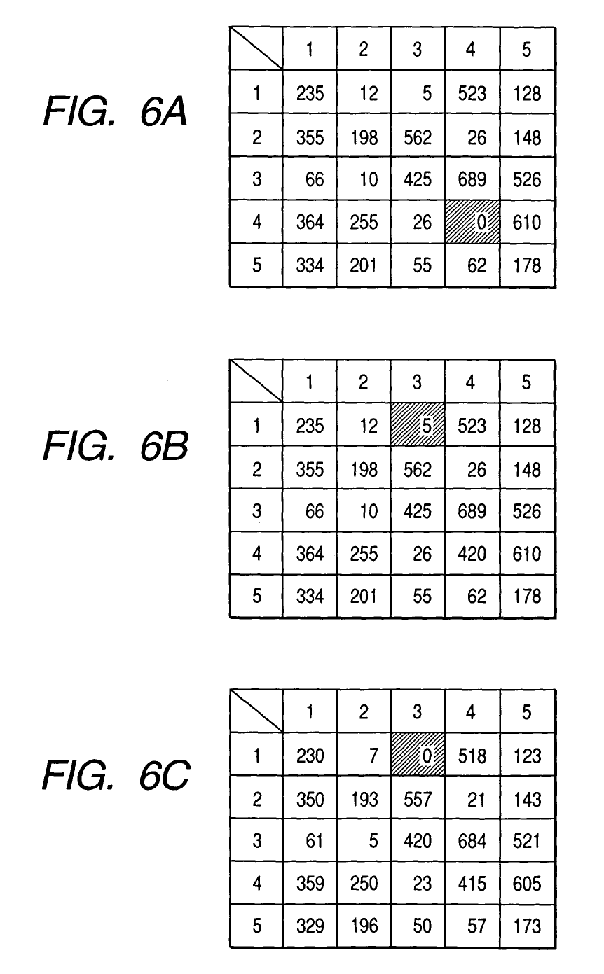

FIG. 5 shows a flow chart of this set value determining operation. FIGS. 6A to 6C show examples of display position history data in which a history of each image display position used for the determination is stored. There are different display position history data for each window display pattern and for each type of an icon. These display position history data are stored in the nonvolatile memory 28. Thus, even if a power supply is turned off, a value of the display position history data before turning off the power supply is held.

The flow chart shown in FIG. 5 starts when multi-window display or icon display is started by some operation of an operator. As an example, an operation in starting the icon display will be described.

First, the CPU 26 reads out display position history data of the pertinent icon display (S1). An example of display position history data is shown in FIGS. 6A to 6C. This display position history data stores data on how many seconds shift patterns are used, respectively, for each display position shift pattern in five directions each horizontally and vertically, that is, twenty-five directions in total. The CPU 26 searches a shift pattern with a value “0” among the shift patterns. In the case of FIG. 6A, a cell (4,4) corresponds to the shift pattern. Here, if there are a plurality of shift patterns with a value “0” (e.g., in the case of an initial state), an arbitrary shift pattern may be selected.

Next, in order to display an image with this shift pattern, the CPU 26 designates the display position of (4,4) and causes the synchronizing signal converter 24 to output a horizontal synchronizing signal and a vertical synchronizing signal that are shifted by four pixels both horizontally and vertically (S2). More specifically, the CPU 26 causes the multiplexers 68 and 78 to select outputs of the D flip-flops 64 and 74. Then, the CPU 26 starts display (S3) and starts a timer for measuring elapsed time (S4). The CPU 26 loops steps S5 and S6 until the icon display is finished (S7), and increments display position history data of the cell (4,4) at every second during that period.

When the icon display is finished (S7), the CPU 26 stops the timer for measuring elapsed time and reads out the display position history data again (S8). An example of the read out display position history data is shown in FIG. 6B. In an example shown in FIG. 6B, data of the cell (4,4) shows that an icon has been displayed for 420 seconds.

The CPU 26 searches a lowest value from each cell shown in FIG. 6B (S9). In FIG. 6B, “5” of the cell (3,1) corresponds to the lowest value. The CPU 26 updates values in all the display position history data to values found by subtracting “5 seconds”, which is the lowest value, from the values (S10). An example of display position history data after update is shown in FIG. 6C. Thereafter, the CPU 26 prepares for the next icon display. As shown in FIG. 6C, a value of the cell (3,1) changes to “0”, and an icon is displayed with a shift pattern of the cell (3,1) in the next icon display.

### Second Embodiment

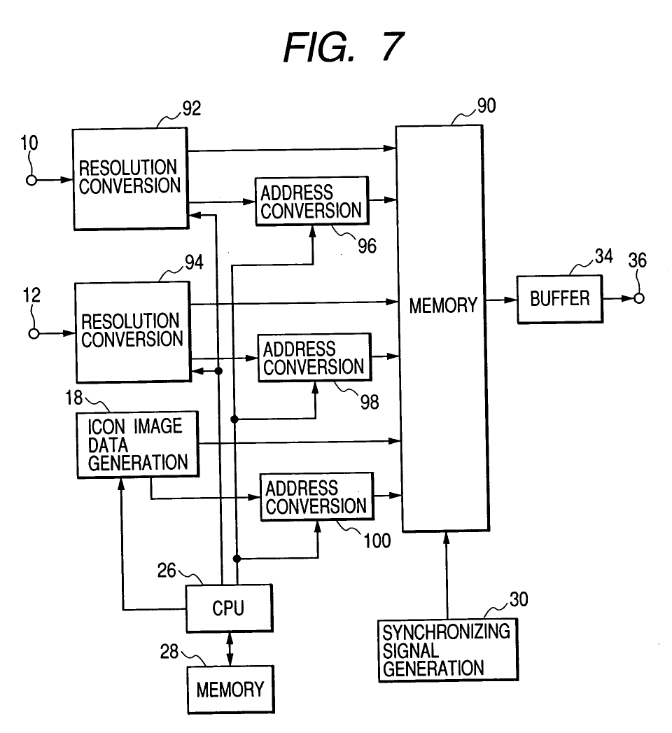

FIG. 7 shows a block diagram of a schematic structure of a second embodiment of the present invention. The same components as those in the embodiment shown in FIG. 1 are denoted by the same reference numerals.

Reference numeral 90 denotes an image memory for storing output image data; 92 and 94, first and second resolution converters for expanding and reducing image data to be inputted from the first and second digital image signal input terminals 10 and 12, respectively; 96 and 98, first and second address converters for converting address data included in image data from the first and second resolution converters 92 and 94; and 100, a third address converter for converting address data included in image data from the icon image data generator 18.

The first and second resolution converters 92 and 94 convert a resolution of image data inputted from the image signal input terminals 10 and 12 in accordance with an instruction from the CPU 26, respectively, thereby converting an image size. The image data with a resolution converted by the resolution converters 92 and 94 and the image data from the icon image data generator 18 are outputted together with coordinate data indicating a position on a screen. When the image data are outputted, priority information corresponding to the instruction from the CPU 26 is added to the image data for each pixel as in the case of the first embodiment.

The priority information is written in a coordinate position of the memory 90 indicated by the coordinate data together with the image data. When the image data is written in the memory 90, priority information of the image data to be written and priority information already written are compared for each pixel. Only when the priority information of the image data to be written has a larger value, the image data is actually written in the memory 90. That is, image data with larger priority information is overwritten in the memory 90 prior to existing image data.

Fixed values designated by the CPU 26 are added to each coordinate data, which is outputted from the resolution converters 92 and 94 and the icon image data generator 18, in the address converters 96, 98 and 100. Then, each coordinate data is applied to the memory 90. When the address converters 96, 98 and 100 adds n to coordinate data in the horizontal direction, the image data is written in a position shifted to the right by n pixels on the memory 90. When m is added to coordinate data in the vertical direction, the image data is written in a position shifted downward by m pixels. The CPU 26 manages the added values n and m based on the display position history data as in the first embodiment.

The image data with a resolution converted by the resolution converters 92 and 94 and the image data from the icon image data generator 18 are written in a storage position corresponding to a display position on the memory 90 according to an instruction from the CPU 26. Image data established on the memory 90 is read out in order in accordance with a synchronizing signal from the synchronizing signal generator 30 and, at the same time, priority information of each pixel is returned to “00” and is prepared for writing in a new frame.

The image data read out from the memory 90 is outputted from the image data output terminal 36 via the image data output buffer 34 as in the first embodiment.

Note that, although a multi-window display position and an icon display position are managed based on display position history data when the positions are determined in the first and second embodiments, a value generated at random within a predetermined range may be used to determine the positions every time multi-window display or icon display is started.

Moreover, a variable range of a display position is not limited only to five pixels both horizontally and vertically but may be values such as two pixels, three pixels or seven pixels, or may be different values horizontally and vertically, respectively.

Although, in display position history data, display time is measured by the unit of one second for each display position, any unit may be adopted such as the unit of ten seconds, thirty seconds or one minute. In symbol display such as an icon, it is considerable that the display automatically ends in a predetermined time from the start of display. A method of changing a display position in order is also possible.

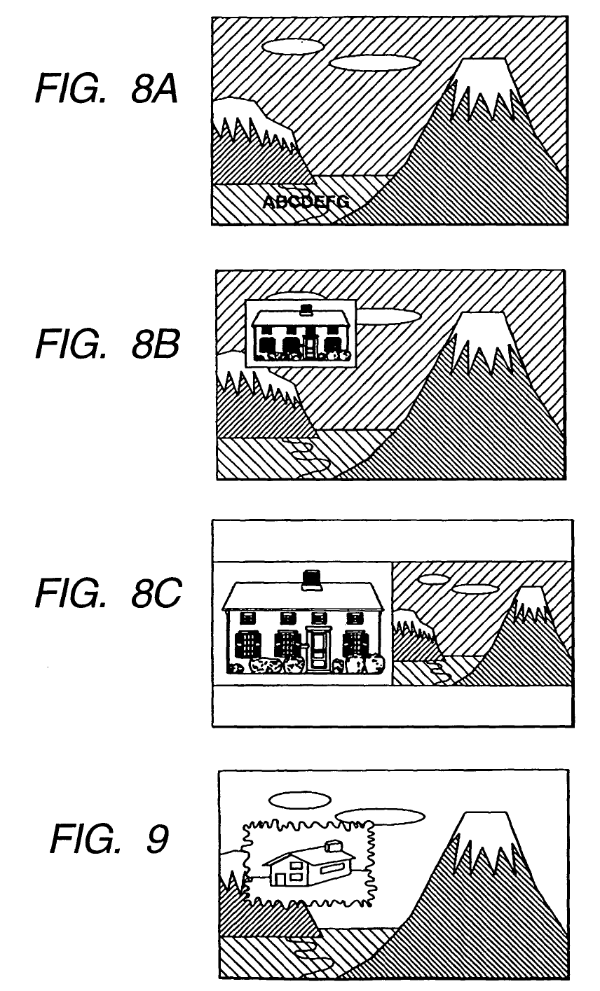

A screen drawn on an image display device using a multi-window composition unit is effective not only for two screens of a reduced size as illustrated in FIG. 2A but also for any combination such as a case in which OSD display is performed on one full screen as shown in FIG. 8A, a case in which a sub-screen is superimposed on one full screen as shown in FIG. 8B, and a case in which two trimmed images are placed side by side as shown in FIG. 8C.

For example, as shown in FIGS. 8A and 8B, if another image is arranged on one full screen, a display position of the image arranged on the one full screen is changed while fixing a display position of the one full screen.

As shown in FIG. 8C, when the two trimmed images are placed side by side, the number of pixels in the lateral direction of both the images is increased so as to be more than the number of pixels in the lateral direction of the display device by several pixels and, then, an image display position having higher priority (to be arranged in the upper side) is changed to the left and the right, whereby a boundary position (trimming portion) of both the images is changed to the left and the right. In the vertical direction, the display positions of both the images are aligned and changed together.

In this way, the present invention is applicable to any combination of images. The number of input sources is not limited to two, and it is possible to implement the present invention with three screens, or four or more screens.

Although each embodiment uses digital image data, it is needless to mention that, if resolution conversion such as expansion or reduction is not required, the same effect can be expected by changing a relative position of a synchronizing signal and an image signal with respect to an analog signal.

### Third Embodiment

A block diagram showing a schematic structure of a multi-window composition unit for a television receiver that is a third embodiment of the present invention is the same as FIG. 1. Thus, its description will be omitted. However, whereas the image data selector 32 is drawn as a switch for one circuit in FIG. 1, the image data selector 32 in this embodiment consists of switches for three channels of R, G and B, or Y, U and V. Each switch changes over referring to priority information added to corresponding component data.

In giving priority information to each image data, the CPU 26 changes a boundary of the image data at random in a range in the order of several pixels such that the boundary does not form a straight line. Consequently, the boundary is drawn as a zigzag line on a composited image. FIG. 9 shows an example of display in which an image of a mountain hut is reduced and displayed over an image of a mountain scenery simultaneously with displaying the image of a mountain scenery.

The priority information to be changed at random in the range in the order of several pixels may be updated for each frame and changed at a speed that does not allow visual distinction, or may be changed every time display is started without being changed during a period from display start to display end.

### Fourth Embodiment

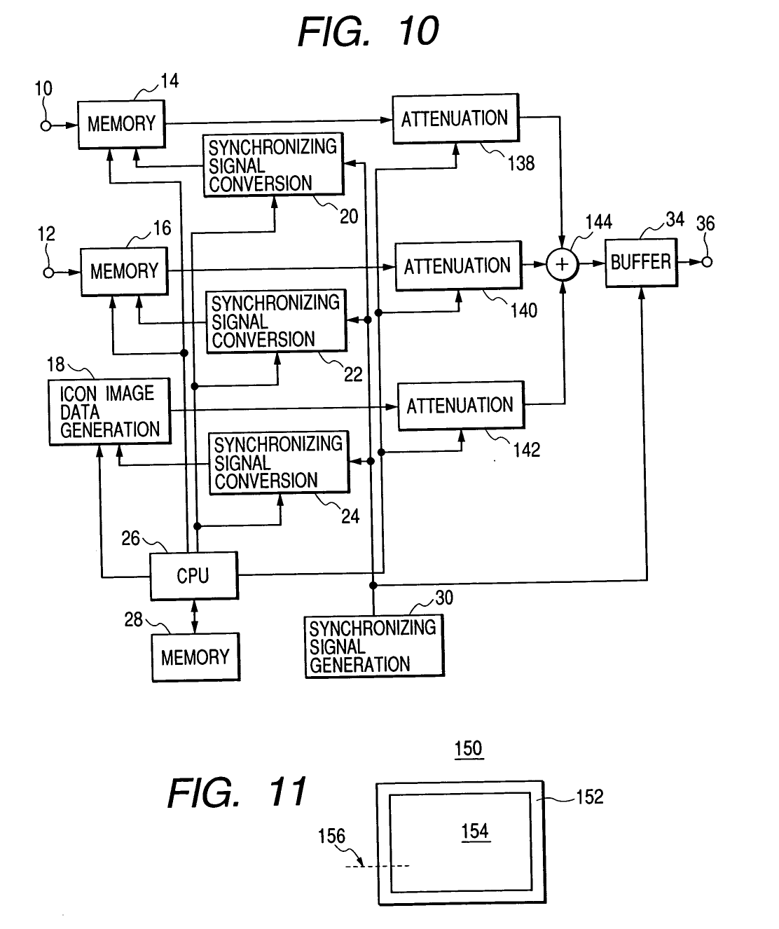

FIG. 10 is a block diagram of a schematic structure of a fourth embodiment that is incorporated in a television receiver. Components performing the same actions as those shown in FIG. 1 are denoted by the same reference numerals. Reference numerals 138 and 140 denote attenuators for reducing amplitude of image data from the first and second image memories 14 and 16 by a factor of ½ or zero, respectively. Reference numeral 142 denotes an attenuator for reducing amplitude of image data from the icon image data generator 18 by a factor of ½ or zero. Reference numeral 144 denotes an adder for adding outputs of the attenuators 138, 140 and 142.

In the case of this embodiment, each input image source may be a YUV signal or an RGB signal. Here, it is assumed to be the RGB signal.

Image data stored in the first and second image memories 14 and 16 are expanded or reduced to an image size corresponding to an instruction from the CPU 26, respectively, and at the same time, priority information of each image and boundary information discussed later are added to the image data. The image data is applied to the attenuators 138 and 140 in accordance with synchronizing signals from the synchronizing signal converters 20 and 22. The icon image data generator 18 outputs an icon image, to which the priority information and the boundary information are added, in accordance with a synchronizing signal from the synchronizing signal converter 124.

The priority information in this case consists of data of two bits added for each pixel as in the case of the third embodiment. As the data, “00” is set in an invalid image period and “01” or “10” is set in a valid image period by the CPU 126. The boundary information consists of data of one bit added for each pixel. As the data, “1” is set to a pixel corresponding to a boundary part of a screen by the CPU 126.

The attenuators 138, 140 and 142 are provided with attenuating means for three channels of R, G and B, respectively. An attenuation ratio is switched with reference to the priority information and the boundary information added to each image data. In the case in which the boundary information is “1”, the attenuation ratio is reduced to half. In the case in which the boundary information is “0”, an attenuation ratio of one is set to image data with highest priority information, and an attenuation ratio of zero (mute) is set to the other image data.

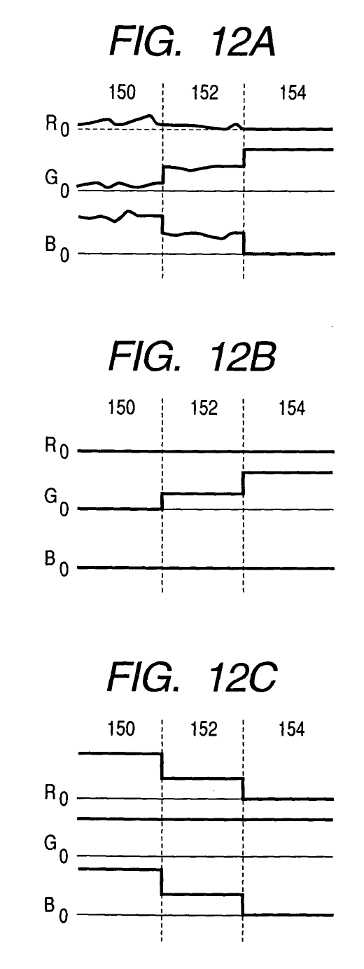

FIG. 11 shows a schematic view of a screen structure for an image generated by the multi-window composition unit shown in FIG. 1. FIG. 12A shows a waveform chart corresponding to FIG. 11. Control of attenuation amounts of the attenuators 138, 140 and 142 based on priority information and boundary information will be described with reference to FIG. 12A. Reference numeral 150 denotes a background image area; 152, a boundary part image area; and 154, an icon image area. In the background image area 150, boundary information of an icon is “0” and priority information of the icon is “00”. In the boundary part image area 152, boundary information of an icon is “1” and priority information of the icon is “11”. In the icon image area 154, boundary information of an icon is “0” and priority information of the icon is “11”. Note that, although image data to be processed is digital data, the image data is illustrated with an analog waveform in FIG. 12A for ease of visual recognition. FIG. 12A shows a signal waveform in a part corresponding to a broken line 156 of FIG. 11. In the example shown in FIG. 12A, an icon of a single color green is superimposed on a bluish background image and displayed.

In the background image area 150, an attenuation ratio of the background image is one and an attenuation ratio of the icon image is zero. In the icon image area 154, conversely, an attenuation ratio of the background image is zero and an attenuation ratio of the icon image is one. In the boundary part image area 152, an attenuation ratio of both the background image and the icon image is half. Each image data is multiplied by weights of these attenuation amounts and, then, composited (added) by the adder 144.

As a result, in the boundary part image area 152, an image (transparent image) in which the background image and the icon image are mixed is formed, which relaxes a sharp change in an RGB signal when the image is displayed.

For reference, a change in an RGB signal in the case in which an icon of a single color green is superimposed on a background image of a single color black is shown in FIG. 12B, and a change in an RGB signal in the case in which an icon of a single color green is superimposed on a background image of a single color white is shown in FIG. 12C.

### Fifth Embodiment

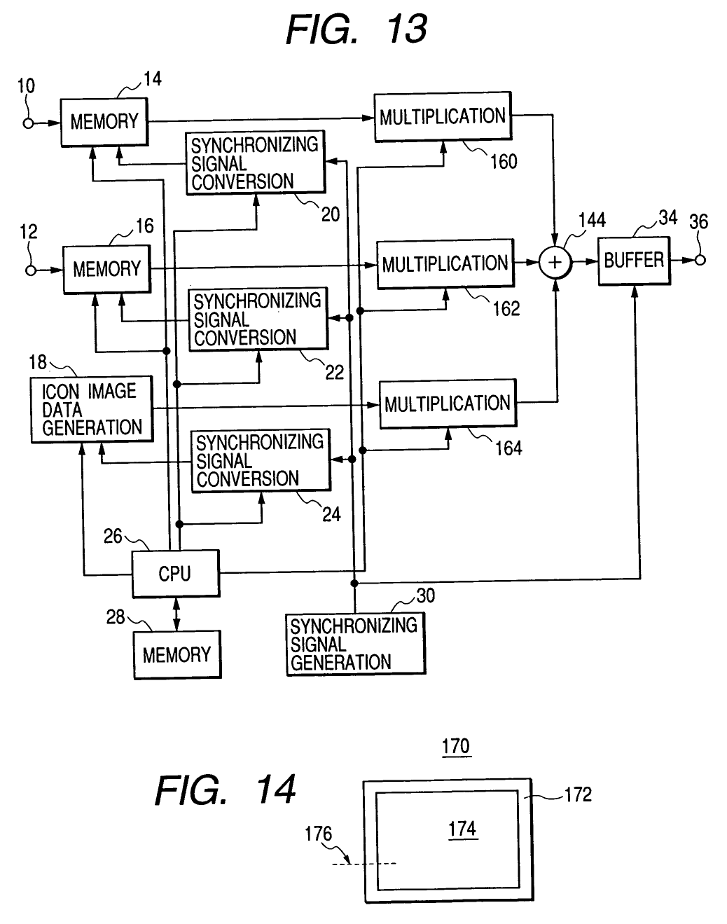

FIG. 13 shows a block diagram of a schematic structure of a fifth embodiment of the present invention. Components performing the same actions as those shown in FIG. 10 are denoted by the same reference numerals. Multipliers 160, 162 and 164 are arranged instead of the attenuators 138, 140 and 142 of the embodiment shown in FIG. 10. Actions of the other components are basically the same as those in the embodiment shown in FIG. 10 except that an attenuation ratio and a multiplier are different. The multipliers 160, 162 and 164 multiply image data from the first and second image memories 14 and 16 and the icon image data generator 18 by a coefficient based on priority information and multiplication information.

An input image source may be a YUV signal or an RGB signal. Here, the case in which the input image source is the RGB signal will be described.

Image data stored in the first and second image memories 14 and 16 are expanded or reduced to an image size corresponding to an instruction from the CPU 26, respectively, and at the same time, priority information and multiplication information of each image are added to the image data. The image data are applied to the multipliers 160 and 162 in accordance with synchronizing signals from the synchronizing signal converters 20 and 22. The icon image data generator 18 outputs an icon image, to which the priority information and the multiplication information are added, in accordance with a synchronizing signal from the synchronizing signal converter 24. Multiplication information is a value set for each pixel in an image boundary part and takes a value from 0 to 100%.

The multipliers 160, 162 and 164 are provided with multiplication means for three channels of R, G and B, respectively. The multipliers 160, 162 and 164 multiply image data with highest priority by multiplication information a (%) that is added to the image data. The multipliers 160, 162 and 164 multiply image data with second highest priority by a coefficient (100-a) (%) that is obtained from the multiplication information a (%) added to the image data with highest priority. The multipliers 160, 162 and 164 multiply image data with third highest or lower priority by 0 (%). The adder 144 adds up each image data subjected to the multiplication processing.

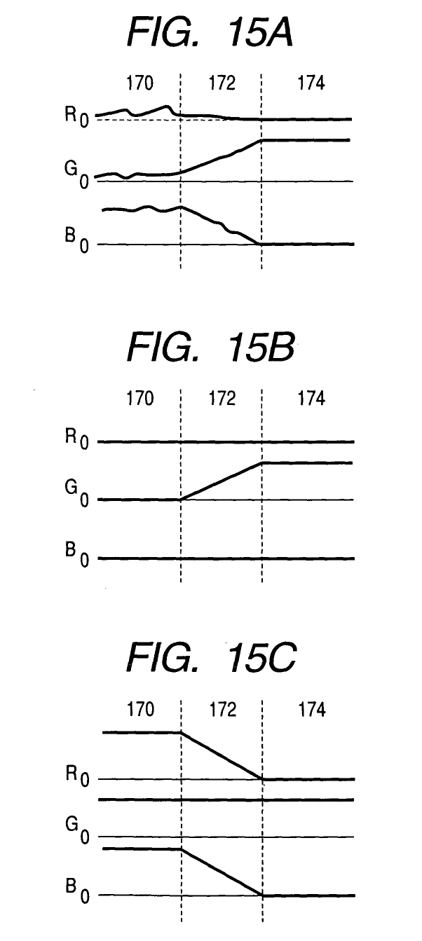

FIG. 14 shows a schematic view of a screen structure for an image generated by the multi-window composition unit shown in FIG. 13. FIGS. 15A, 15B and 15C show waveform charts corresponding to FIG. 14. Actions of the multipliers 160, 162 and 164 based on priority information and multiplication information will be described with reference to FIG. 15A. Reference numeral 170 denotes a background image area; 172, a boundary part gradation image area; and 174, an icon image area. In the background image area 170, priority information of an icon is “00”. In the boundary part gradation image area 172, priority information of an icon is “11” and multiplication information of the icon is less than 100 (%). In the icon image area 174, priority information of an icon is “11” and multiplication information of the icon is 100 (%) . Note that, although image data to be processed is digital data, the image data is illustrated with an analog waveform in FIG. 15A. FIG. 15A shows a signal waveform in a part corresponding to a broken line 176 of FIG. 14. In the example shown in FIG. 15A, an icon of a single color green is superimposed on a bluish background image and displayed.

In the background image area 170, priority of a background image is highest, and background image data is multiplied by multiplication information (a 100 (%)) added to the background image data and the other image data is multiplied by 0 (=100-a) (%). In addition, in the icon image area 174, conversely, priority of icon image data is high, background image data is multiplied by 0 (%), and icon image data is multiplied by 100 (%).

In the boundary part gradation image area 172, multiplication information “a” that gradually changes is added. More specifically, “a” equals to 0 (%) in its outermost peripheral part, gradually increases toward its inner periphery, and reaches 100 (%) in its innermost peripheral part. The adder 144 mixes an icon image and a background image based on this multiplication information at a ratio of a (%) to (100-a) (%)

As a result, in the boundary part gradation image area 172, an image (transparent image) is obtained in which the background image is mixed with the icon image and the mixed image gradually switched to the icon image from the outer periphery toward the inner periphery. In this way, when the mixed image is displayed by a not-shown image display device, a sharp change in an RGB signal is relaxed.

For reference, a change in an RGB signal in the case in which an icon of a single color green is superimposed on a background image of a single color black is shown in FIG. 15B, and a change in an RGB signal in the case in which an icon of a single color green is superimposed on a background image of a single color white is shown in FIG. 15C.

### Sixth Embodiment

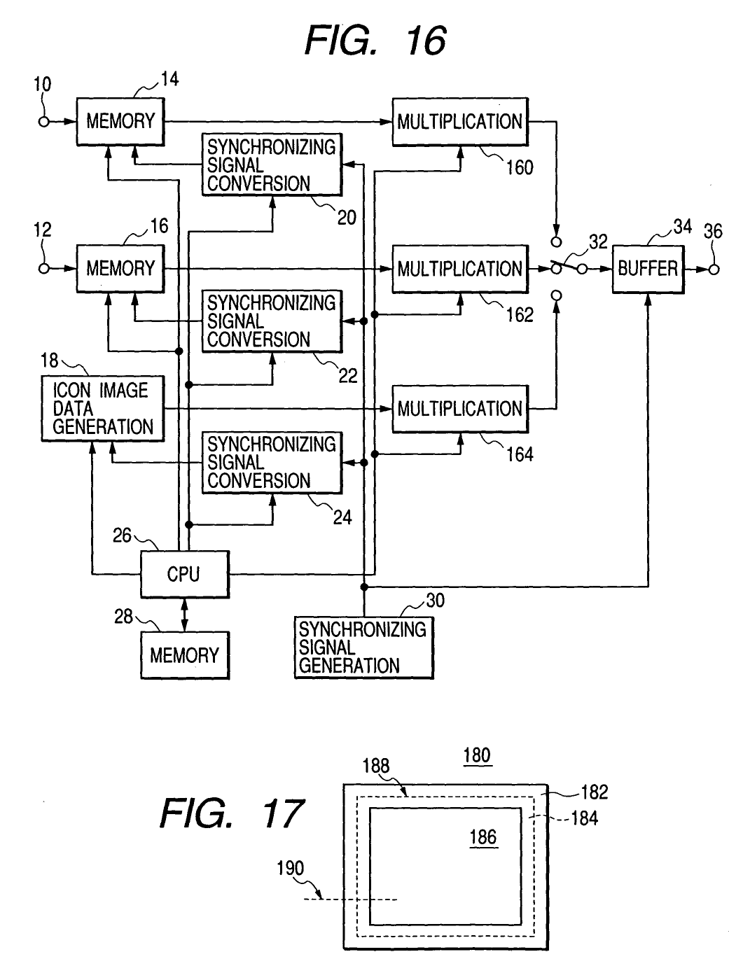

FIG. 16 shows a block diagram of a schematic structure of a sixth embodiment of the present invention. Components performing the same actions as those shown in FIGS. 1, 10 and 13 are denoted by the same reference numerals.

Image data stored in the first and second image memories 14 and 16 are expanded or reduced to an image size corresponding to an instruction from the CPU 26, respectively, and at the same time, priority information and multiplication information of each image are added to the image data. The image data are applied to the multipliers 160 and 162 in accordance with synchronizing signals from the synchronizing signal converters 20 and 22. The icon image data generator 18 outputs an icon image, to which the priority information and the multiplication information are added, in accordance with a synchronizing signal from the synchronizing signal converter 24. The multiplication information is a value set for one pixel in an image boundary part and takes a value between 0 to 100%.

An input image source may be a YUV signal or an RGB signal. However, the case in which the input image is the YUV signal will be described here.

The multipliers 160, 162 and 164 are provided with multiplication means for three channels of R, G and B, respectively. The data selector 32 is also provided with switches for the three channels. The multipliers 160, 162 and 164 multiply each image data by multiplication information a (%) added to each image data. The multipliers 160, 162 and 164 add fixed data of 0.3×(100-a) (%) to the Y signal and add fixed data of 0.5×(100-a) (%) to the U and V signals. That is, as “a” decreases, the Y signal is brought close to a signal of 30IRE level, and the U and V signals of 8-bit gradation (256 gradation) are brought close to “128 h”, that is, a center level that is a value in the case of no color.

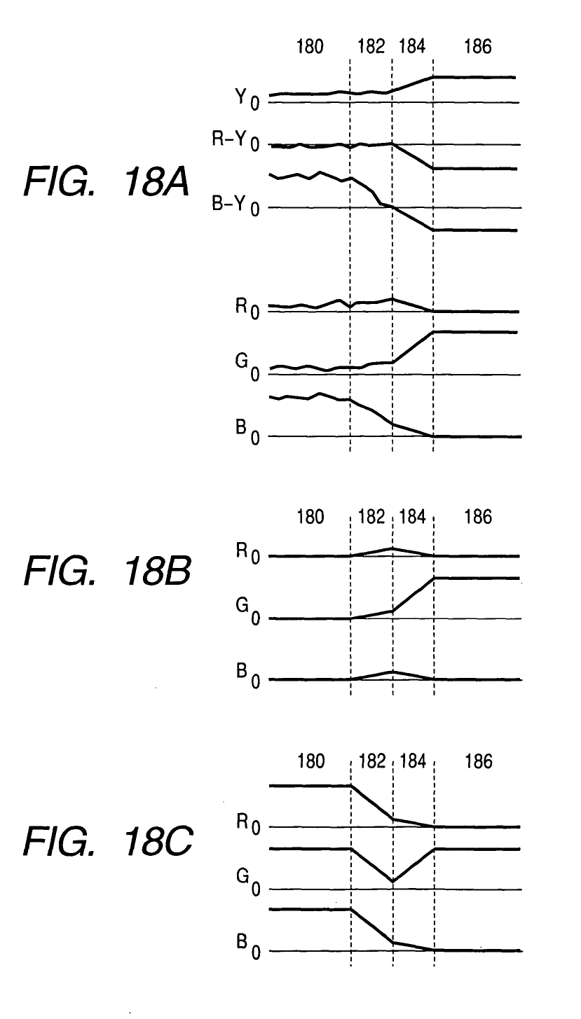

FIG. 17 shows a schematic view of a screen structure for an image generated by a multi-window composition unit shown in FIG. 16. FIGS. 18A to 18C show waveform charts corresponding to FIG. 17. Actions of the multipliers 160, 162 and 164 based on priority information and multiplication information will be described with reference to FIG. 18A. Reference numeral 180 denotes a background image area; 182, a background part gradation image area; 184, an icon part gradation image area; 186, an icon image area; and 188, a boundary between the background part gradation image area 182 and the icon part gradation image area 184.

Note that, although image data to be processed is digital data, the image data is illustrated with an analog waveform in FIG. 18A for ease of visual recognition. For ease of comparison with other embodiments, an RGB signal waveform is also illustrated. FIG. 18A shows a signal waveform in a part corresponding to a broken line 190 of FIG. 17. In the example shown in FIG. 18A, an icon of a single color green is superimposed on a bluish background image and displayed.

Since priority information of an icon is “00” in the background image area 180 and the background part gradation image area 182, the image data selector 132 selects background image data. Since priority information on an icon is “11” in the icon image area 186 and the icon part gradation image area 184, the image data selector 132 selects icon image data.

In the background part gradation image area 182, background image multiplication information “a” equals to 100 (%) in its outermost peripheral part, gradually decreases toward its inner periphery, and reaches 0 (%) in the boundary 188. Similarly, in the icon part gradation image area 184, icon image multiplication information “a” equals to 0 (%) in its outermost peripheral part and gradually increases toward its inner periphery to reach 100 (%). That is, contrast is gradually decreased toward the inner periphery in the background part gradation image area 182 and toward the outer periphery in the icon part gradation image area 184, respectively, to reach gray of 30IRE in the boundary 188.

In this way, the background image and the icon image are switched while gradually changing to gray of 30IRE in the background part gradation image area 182 and the icon part gradation image area 184, which are boundary parts of both the images, whereby a sharp changes in RGB of a displayed image is relaxed.

For reference, a change in an RGB signal in the case in which an icon of a single color green is superimposed on a background image of a single color black is shown in FIG. 18B, and a change in an RGB signal in the case in which an icon of a single color green is superimposed on a background image of a single color white is shown in FIG. 18C.

### Seventh Embodiment

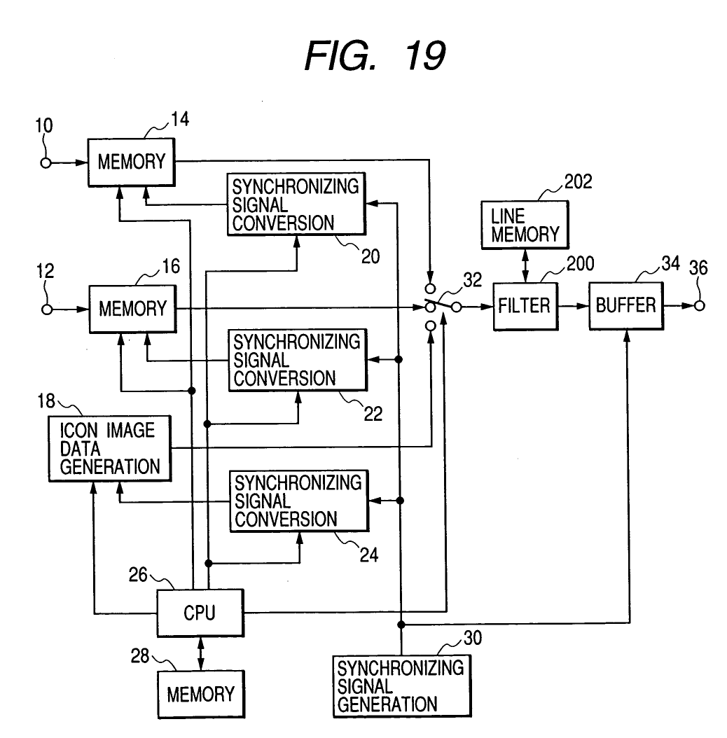

FIG. 19 shows a block diagram of a schematic structure of a seventh embodiment of the present invention. Components performing the same actions as those shown in FIGS. 1, 10, 13 and 16 are denoted by the same reference numerals. Reference numeral 200 denotes a filter for adding pixel data of pixels around the filter, and 200 denotes a line memory for two lines used in filtering processing.

Image data stored in the first and second image memories 14 and 16 are expanded or reduced to an image size corresponding to an instruction from the CPU 26, respectively, and at the same time, priority information is added to the image data. The image data are read out in accordance with synchronizing signals from the synchronizing signal converters 20 and 22. The icon image data generator 18 outputs an icon image, to which the priority information is added, in accordance with a synchronizing signal from the synchronizing signal converter 24. The image data selector 32 selects any one of image data from the first and second image memories 14 and 16 and the icon image data from the icon image data generator 18 by the unit of a pixel in accordance with an instruction from the CPU 26.

In this embodiment, again, each input image may be a YUV signal or an RGB signal.

The filter 200 applies filtering processing in accordance with an instruction from the CPU 26 to the image data selected by the image data selector 32. This filtering processing is roughly divided into three types. One of them is lateral filtering, which replaces image data of interest with a value found by adding pixel data of a pixel of interest by 50% and pixel data of two pixels adjacent to the pixel of interest on its left and right sides by 25%, respectively. Another one is longitudinal filtering, which replaces pixel data of interest with a value found by adding pixel data of a pixel of interest by 50% and pixel data of two pixels adjacent to the pixel of interest above and below it by 25%, respectively. In this processing, image data for three lines are required vertically, and the line memory 202 for two lines is used. Third filtering processing is all direction filtering, which replaces pixel data of interest with a value found by adding pixel data of a pixel of interest by 25%, pixel data of four pixels adjacent to the pixel of interest above and below it, and on its left and right by 12.5%, and pixel data of four pixels adjacent to the pixel of interest in its oblique direction by 6.25%. The all direction filtering is equivalent to performing the processing of both the lateral filtering and the longitudinal filtering and can be realized without particularly preparing processing means for three types.

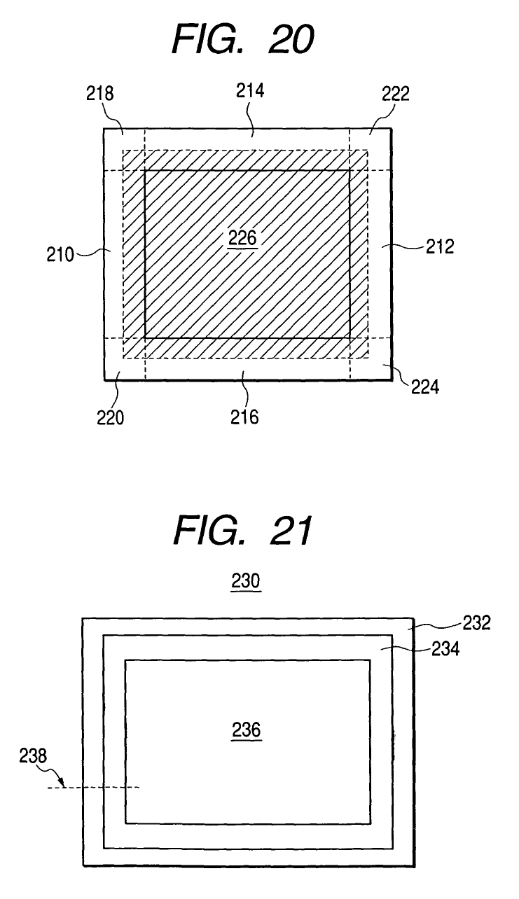

FIG. 20 is a schematic view of a display screen structure of image data generated by a multi-window composition unit shown in FIG. 19 and shows the case in which an icon image is superimposed on a background image.

When the icon image is superimposed on the background image, the CPU 26 instructs the filter 200 to perform the filtering processing at timing close to a boundary position between the icon image and the background image. In the case of FIG. 20, an area 226 subjected to hatching processing is an icon image. Reference numerals 210 and 212 denote lateral boundary areas; 214 and 216, longitudinal boundary areas; and 218, 220, 222 and 224, corner boundary areas. The CPU 26 instructs the filter 200 to apply the lateral filtering processing to the lateral boundary areas 210 and 212, the longitudinal filtering processing to the longitudinal boundary areas 214 and 216, and the all direction filtering processing to the corner boundary areas 218, 220, 222 and 224, and does not perform the filtering processing in the other areas.

In this way, the filtering processing is applied to the area of several pixels in front, rear, left and right of the boundary between the icon image and the background image, whereby a sharp change in an RGB signal can be relaxed when it is displayed by a not-shown image display device.

### Eighth Embodiment

The multi-window composition unit of the structure shown in FIG. 1 is operated as follows. That is, Y, U and V image data stored in the first and second image memories 14 and 16 are expanded or reduced to an image size corresponding to an instruction from the CPU 28, respectively, and at the same time, priority information and boundary information of each image are added to the image data. The image data are supplied to the image data selector 32 in synchronism with a synchronizing signal from the synchronizing signal converters 20 and 22. The priority information in this case consists of data of two bits added for each pixel. As the priority information, “00” is set for an invalid image period, “01” or “10” is set for a valid image period according to an instruction from the CPU 26. In addition, the boundary information consists of data of one bit added for each pixel. As the boundary information, “1” is set for a pixel in a boundary part and “0” is set for pixels in the other parts according to an instruction from the CPU 26.

The icon image data generator 18 generates icon image data in accordance with an instruction from the CPU 26. The icon image data is supplied to the image data selector 32 together with the priority information and the boundary information in synchronism with a synchronizing signal from the synchronizing signal converter 24. Note that, as the priority information of the icon image data, “11” is given to a pixel in which an icon exists and “00” is given to a pixel in which no icon exists and, as the boundary information, “1” is set only in the boundary part according to an instruction from the CPU 26 as in the case of the image data.

The image data selector 32 consists of switches for three channels of Y, U and V. Each switch changes over with reference to priority information and boundary information that are added to corresponding component data.

In the case of the Y signal, the image data selector 32 operates based only on priority information. The image data selector 32 selects image data to which priority information with a largest value is given for each pixel. The image data selector 32 does not select any image data if priority information is “00” for all the image data and replaces all bits of image data with “0”.

In the case of the U and V signals, the image data selector 32 uses both of priority information and boundary information. If the boundary information is “1”, the image data selector 32 replaces U and V signals of 8-bit gradation (256 gradation) with “128 h”, that is, a center level that is a value in the case of no color. In the case in which the boundary information is “0”, the image data selector 32 refers to the priority information and selects image data to which priority information with a largest value is given. The image data selector 32 does not select any image data if priority information is “00” for all the image data and replaces the image data with “128 h”.

In this way, the image data selector 32 composites each image data. A result of the composition is outputted from the image data output terminal 36 via the image data output buffer 34. The image data outputted from this terminal is displayed by a not-shown image display device.

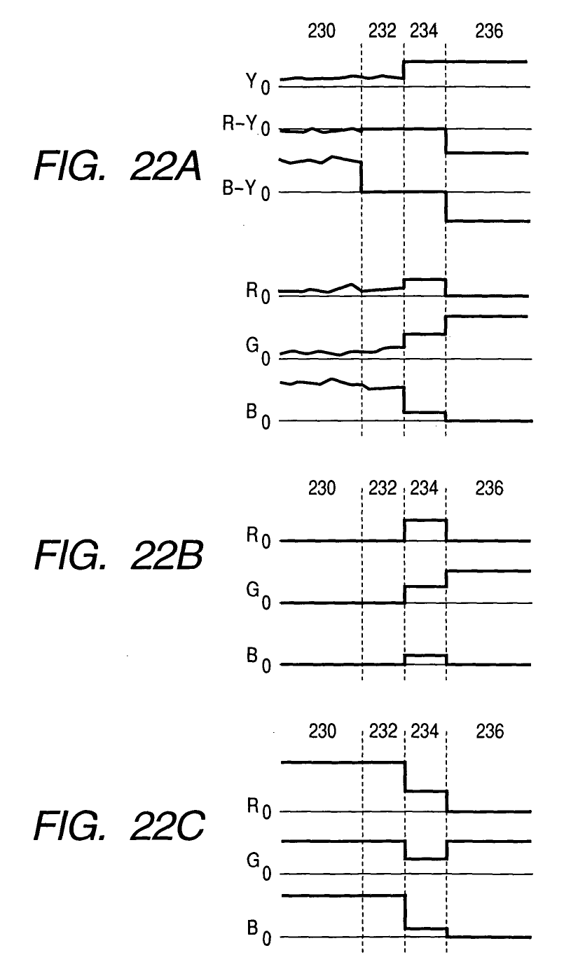

FIG. 21 shows a screen structure in this operation. FIG. 22A shows an example of a signal waveform in a part corresponding to a broken line 238 of FIG. 21. Although image data to be processed is digital data, the image data is illustrated with an analog waveform in FIG. 22A for ease of visual recognition. In FIG. 22A, an output signal of the image data selector 32 is illustrated in both of the YUV system and the RGB system. Reference numeral 230 denotes a background image area; 232, a boundary part background side image area; 234, a boundary part icon side image area; and 236, an icon image area. In the background image area 230, boundary information of an icon is “0” and priority information of the icon is also “00”. In the boundary part background side image area 232, boundary information of an icon is “1” and priority information of the icon is “00”. In the boundary part icon side image area 234, boundary information of an icon is “1” and priority information of the icon is “11”. In the icon image area 236, boundary information is “0” and priority information is “11”.

FIG. 22A shows an example of a signal waveform of a part corresponding to the broken line 238 of FIG. 21, which is a waveform at the time when an icon of a single color green is superimposed on a bluish background image and displayed.

In the background image area 230, a background image is selected for both the Y signal and the U and V signals. In the icon image area 236, an icon image is selected for both the Y signal and the U and V signals. In the boundary part background side image area 232 and the boundary part icon side image area 234, the U and V signals are muted (replaced with “128 h”), and the background image and the icon image are selected, respectively, for the Y signal. As a result, a black and white image is displayed only on the boundary part background side image area 232 and the boundary part icon side image area 234, whereby a sharp change in an RGB signal at the time when an image is displayed is relaxed.

For reference, a change in an RGB signal in the case in which an icon image of a single color green is superimposed on a background image of a single color black is shown in FIG. 22B. A change in an RGB signal in the case in which an icon image of a single color green is superimposed on a background image of a single color white is shown in FIG. 22C.

### Ninth Embodiment

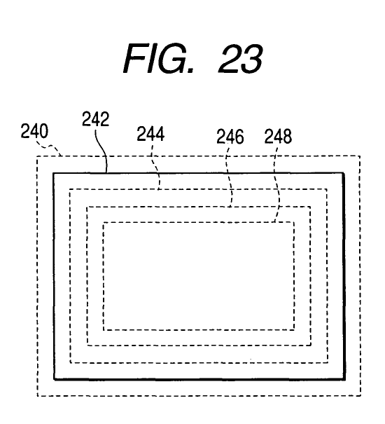

The multi-window composition unit of the structure shown in FIG. 1 is operated as follows. That is, image data stored in the first and second image memories 14 and 16 are expanded or reduced to an image size corresponding to an instruction from the CPU 26, respectively. In this case, an expansion or reduction ratio of the image data is changed subtly every time the image data is expanded or reduced. For example, any one of five kinds of expansion or reduction ratios as indicated by reference numerals 240 to 246 in FIG. 23 is appropriately selected to perform screen composition processing. Consequently, a boundary of icons or the like is prevented from being written repeatedly in a specific pixel position.

An expansion or reduction ratio to be applied may be determined at random out of the five kinds of expansion or reduction ratios. Alternatively, it is also possible to store an accumulated display time of each expansion or reduction ratio in a nonvolatile memory such as an EEPROM and select each expansion or reduction ratio such that a frequency of use of each expansion or reduction ratio becomes equal.

It is evident that the expansion or reduction ratio is not limited to five kinds as in this example.

Note that, although processing of a boundary part at the time of icon display is described as the third to ninth embodiments, it is needless to mention that the present invention is effective for any combination such as a case in which OSD display is performed on one full screen, a case in which sub-screens are superimposed on one full screen, and a case in which two trimmed images are placed side by side. In addition, the number of input sources is not limited to two screens, and the present invention can be implemented with three or more screens.

Further, some of the embodiments may be combined and used, for example, the third embodiment and the eighth embodiment are applied simultaneously to display only a “zigzag” boundary part, which changes every time an image is expanded or reduced, in black and white.

Although the embodiments for using digital image data have been described, the same effects can be obtained with respect to an analog signal.

As described above, according to the present invention, a display position of a symbol image or a multi-window display is appropriately changed by shifting several pixels to be changed to prevent the symbol image or the multi-window display from being always displayed in an identical position, whereby persistence of a fixed pattern can be prevented or reduced.

In addition, a display boundary part of a symbol image or a multi-window display is blurred or the display boundary part is changed subtly every time the symbol image or multi-window display is displayed, whereby persistence of a fixed pattern can be prevented or made less conspicuous.

What is claimed is:

1. An image processing apparatus, comprising:
input means for inputting first image data and second image data;
determining means for determining a display position of the second image; and
display control means for superimposing one of the first image and the second image on the other and displaying the first and second images on a monitor such that the second image is positioned in the display position determined by the determining means,
wherein the determining means determines a display position of the second image such that the display position is changed within a range that is apart from the display position determined last time by a predetermined number of pixels.

2. An apparatus according to claim 1, further comprising:
instruction means for instructing display of the second image on the monitor,
wherein the determining means determines a display position of the second image according to an instruction by the instruction means.

3. An apparatus according to claim 1,
wherein the determining means changes a display position of the second image to an arbitrary position within the range.

4. An apparatus according to claim 1, further comprising:
storage means for calculating and storing an accumulated display time in respective display positions determined by the determining means,
wherein the determining means determines that a position where the accumulated display time is minimum among the respective display positions is a display position of the second image.

5. An apparatus according to claim 1, further comprising:
image generation means for generating an object image,
wherein the display control means controls display such that the object image generated by the image generation means is superimposed on the first image as the second image and displayed.

6. An apparatus according to claim 5,
wherein the object image includes an icon image or a boundary of images.

7. An apparatus according to claim 1, further comprising:
image size conversion means for expanding or reducing the second image,
wherein the display control means controls display such that the second image expanded or reduced by the image size conversion means is superimposed on the first image.

8. An apparatus according to claim 7,
wherein the image size conversion means expands or reduces the first image, and the display control means displays the first and second images expanded or reduced by the image size conversion means on an identical screen of the display means.

9. An image processing method, comprising:
input step for inputting first image data and second image data;
a determining step for determining a display position of the second image; and
a display control step for superimposing one of the first image and the second image on the other and displaying the first and second images on a monitor such that the second image is positioned in the display position determined by the determining step;
wherein in the determining step, a display position of the second image is determined such that the display position is changed within a range that is apart from the display position determined last time by a predetermined number of pixels.

10. A method according to claim 9, further comprising:
an instruction step for instructing display of the second image on the monitor,
wherein in the determining step, a display position of the second image is determined according to an instruction issued in the instruction step.

11. A method according to claim 9,
wherein in the determining step, a display position of the second image is changed to an arbitrary position within the range.

12. A method according to claim 9, further comprising:
a storage step for calculating and storing an accumulated display time in respective display positions determined in the determining step,
wherein in the determining step, a position where the accumulated display time is minimum among the respective display positions is determined as a display position of the second image.

13. An image processing apparatus, comprising:
input means for inputting image data;
image generation means for generating an object image; and
image composition means for compositing the object image generated by the image generation means with respect to the image inputted by the input means in a predetermined position,
wherein the image composition means applies predetermined processing to a boundary between the image and the object image so as to make the boundary unclear.

14. An apparatus according to claim 13,
wherein the object image includes an icon image or a display frame framing the image.

15. An apparatus according to claim 13,
wherein the image composition means draws the boundary of the object image as a zigzag line that changes every time the object image is displayed or at every predetermined time interval.

16. An apparatus according to claim 13,
wherein the image composition means adds the image and the object image at a predetermined ratio in the boundary of the object image.

17. An apparatus according to claim 16,
wherein the image composition means gradually changes the adding ratio of the image and the object image in a predetermined direction of the boundary.

18. An apparatus according to claim 13,
wherein the image composition means makes the boundary between the image and the object image black and white.

19. An image processing method, comprising:
an input step for inputting image data;
an image generation step for generating an object image; and
an image composition step for compositing the object image generated in the image generation step with respect to the image inputted in the input step in a predetermined position,
wherein in the image composition step, a predetermined processing is applied to a boundary between the image and the object image so as to make the boundary unclear.

20. A method according to claim 19,
wherein the object image includes an icon image or a boundary of images.

21. A method according to claim 19,
wherein in the image composition step, the boundary is drawn between the image and the object image as a zigzag line that changes every time the object image is displayed or at every predetermined time interval.

22. A method according to claim 19,
wherein in the image composition step, the image and the object image are added at a predetermined ratio in the boundary between the image and the object image.

23. A method according to claim 22,
wherein in the image composition step, the adding ratio of the image and the object image is gradually changed in a predetermined direction of the boundary.

24. A method according to claim 19,
wherein in the image composition step, the boundary between the image and the object image is made black and white.
